(19) United States
(12) Patent Application Publication
(10) Pub. No.: US 2016/0360437 A1
(43) Pub. Date: Dec. 8, 2016

(54) CSI Reporting and Measurement for LAA SCells

(71) Applicant: TELEFONAKTIEBOLAGET LM ERICSSON (PUBL), Stockholm (SE)

(72) Inventors: Daniel Larsson, Stockholm (SE); Havish Koorapaty, Saratoga, CA (US)

(73) Assignee: Telefonaktiebolaget LM Ericsson (PUBL), Stockholm (SE)

(21) Appl. No.: 15/027,824

(22) PCT Filed: Jan. 29, 2016
(86) PCT No.: PCT/SE2016/050063

§ 371 Date: Apr. 7, 2016

Related U.S. Application Data
(60) Provisional application No. 62/109,937, filed on Jan. 30, 2015.

(51) Int. Cl. H04W 24/10; H04W 72/04; H04L 5/00

(52) U.S. Cl. CPC H04W 24/10; H04L 5/0048; H04W 72/0466

(57) ABSTRACT

A wireless device, a network node and respective methods performed thereby for communicating with each other are provided. The method performed by the wireless device comprises acquiring (S1) an indicator, wherein the indicator indicates presence of a reference signal; and performing (S2) measurements on the reference signal based on whether the indicator was acquired.

### TECHNICAL FIELD

The present disclosure generally relates to Channel-State Information (CSI) reporting for down-link (DL) in License assisted access.

### BACKGROUND

The 3GPP initiative “License Assisted LTE” (LA-LTE) aims to allow LTE equipment to operate in the unlicensed 5 GHz radio spectrum. The unlicensed 5 GHz spectrum is used as an extension to the licensed spectrum. Accordingly, devices connect in the licensed spectrum (primary cell or PCell) and use carrier aggregation to benefit from additional transmission capacity in the unlicensed spectrum (secondary cell or SCell). To reduce the changes for aggregating licensed and unlicensed spectrum, the LTE frame timing in the primary cell is simultaneously repeated in the secondary cell.

Regulatory requirements, however, may not permit to transmit in the unlicensed spectrum without prior channel sensing. Since the unlicensed spectrum can be shared with other radios of similar or dissimilar wireless technologies, a so called listen-before-talk (LBT) method are often applied. Today, the unlicensed 5 GHz spectrum is mainly used by equipment implementing the IEEE 802.11 Wireless Local Area Network (WLAN) standard. This standard is known under its marketing brand “Wi-Fi.”

IEEE 802.11 equipment uses a contention based medium access scheme. This scheme does not allow the wireless medium to be reserved at specific instances of time. Instead IEEE 802.11 compliant devices only support the immediate reservation of the wireless medium following the transmission of at least one medium reservation message (e.g. Request to Transmit (RTS) or Clear to Transmit (CTS) or others). To allow the LA-LTE frame in the secondary cell to be transmitted at recurring time intervals that are determined by the LTE frame in the primary cell it is proposed that an LA-LTE system transmits at least one of the aforementioned medium reservation messages to block surrounding IEEE 802.11 compliant devices from accessing the wireless medium. LTE (Long Term Evolution) uses OFDM in the downlink and DFT-spread OFDM in the uplink. The basic LTE downlink physical resource can thus be seen as a time-frequency grid as illustrated in FIG. 1 where each resource element corresponds to one OFDM subcarrier during one OFDM symbol interval.

In the time domain, LTE downlink transmissions are organized into radio frames of 10 ms, each radio frame consisting of ten equally-sized subframes of length Tsubframe=1 ms. For normal cyclic prefix, one subframe consists of 14 OFDM symbols. The duration of each OFDM symbol is approximately 71.4 μs. In FIG. 2 there is an example illustration of how LTE radio frames are divided into subframes.

Furthermore, the resource allocation in LTE is typically described in terms of resource blocks, where a resource block corresponds to one slot (0.5 ms) in the time domain and 12 contiguous subcarriers in the frequency domain. A pair of two adjacent resource blocks in time direction (1.0 ms) is known as a resource block pair. Resource blocks are numbered in the frequency domain, starting with 0 from one end of the system bandwidth.

Downlink transmissions are dynamically scheduled, i.e., in each subframe the base station transmits control information about to which terminals data is transmitted and upon which resource blocks the data is transmitted, in the current downlink subframe. This control signaling is typically transmitted in the first 1, 2, 3 or 4 OFDM symbols in each subframe and the number n=1, 2, 3 or 4 is known as the Control Format Indicator (CFI). The downlink subframe also contains common reference symbols, which are known to the receiver and used for coherent demodulation of e.g. the control information. A downlink system with CFI=3 OFDM symbols as control is illustrated in FIG. 3.

From LTE Rel-11 onwards above described resource assignments can also be scheduled on the enhanced Physical Downlink Control Channel (EPDCCH). For Rel-8 to Rel-10 only Physical Downlink Control Channel (PDCCH) is available.

The reference symbols shown in the above FIG. 3 are the cell specific reference symbols (CRS) and are used to support multiple functions including fine time and frequency synchronization and channel estimation for certain transmission modes.

In a cellular communication system it is usual to measure the channel conditions in order to know what transmission parameters to use. These parameters include, e.g., modulation type, coding rate, transmission rank, and frequency allocation. This applies to uplink (UL) as well as downlink (DL) transmissions.

The scheduler that makes the decisions on the transmission parameters is typically located in the base station (eNB). Hence, it can measure channel properties of the UL directly using known reference signals that the terminals (UEs) transmit. These measurements then form a basis for the UL scheduling decisions that the eNB makes, which are then sent to the UEs via a downlink control channel.

However, for the DL the eNB is unable to measure any channel parameters. Rather, it may rely on information that the UEs can gather and subsequently send back to the eNB. This so-called Channel-State Information (CSI) is obtained in the UEs by measuring on known reference symbols, Channel-State Information Reference Symbols (CSI-RS), transmitted in the DL.

The CSI-RS are UE specifically configured by radio resource signaling (RRC), with a certain configured periodicity, T={5, 10, 20, 40, 80} ms (i.e. every Tth subframe). There is a possibility to configure both non-zero power (NZP) CSI-RS and zero power (ZP) CSI-RS where the ZP CSI-RS is simply an unused resource that can be matched to a NZP CSI-RS in an adjacent eNB. This will improve the SINR for the CSI-RS measurements in the adjacent cell. The ZP CSI-RS can also be used as CSI-IM as introduced in Rel. 11 and explained below.

In LTE, the format of the CSI reports are specified in detail and may contain CQI (Channel-Quality Information), Rank Indicator (RI), and Precoding Matrix Indicator. The reports can be wideband or applicable to subbands. They can be configured by a radio resource control (RRC) message to be sent periodically or in an aperiodic manner, triggered by a control message from the eNB to a UE. The quality and reliability of the CSI are crucial for the eNB in order to make the best possible scheduling decisions for the upcoming DL transmissions.

The LTE standard does not specify in detail how the UE should obtain and average these measurements from multiple time instants. For example, the UE may measure over a time frame unknown to the eNB and combine several measurements in a UE-proprietary way to create the CSI-values that are reported, either periodically or triggered.

In the context of LTE, the available CSI-RS are referred to as “CSI-RS resources”. In addition, there are also “CSI-IM resources”, where IM stands for “Interference Measurement”. The latter are defined from the same set of possible physical locations in the time/frequency grid as the CSI-RS, but with zero power, hence ZP CSI-RS. In other words, they are “silent” CSI-RS and when the eNB is transmitting the shared data channel, it avoids mapping data to those resource elements used for CSI-IM. These are intended to give a UE the possibility to measure the power of any interference from another transmitter than its serving node.

Each UE can be configured with one, three or four different CSI processes. Each CSI process is associated with one CSI-RS and one CSI-IM where these CSI-RS resources has been configured to the UE by RRC signaling and are thus periodically transmitted/occurring with a periodicity of T and with a given subframe offset relative to the frame start.

If only one CSI process is used, then it is common to let the CSI-IM reflect the interference from all other eNB, i.e. the serving cell use a ZP CSI-RS that overlaps with the CSI-IM, but in other adjacent eNB, there is no ZP CSI-RS on these resources. In this way will the UE measure the interference from adjacent cells using the CSI-IM.

If additional CSI processes are configured to the UE, then there is possibility for the network to also configure a ZP CSI-RS in the adjacent eNB that overlaps with a CSI-IM for this CSI process for the UE in the serving eNB. In this way the UE will accurately feedback CSI also for the case when this adjacent cell is not transmitting. Hence coordinated scheduling between eNBs is enabled with the use of multiple CSI processes and one CSI process feeds back CSI for full interference case and the other CSI process feedback CSI for the case when a (strong interfering) adjacent cell is muted. As mentioned above, up to four CSI processes can be configured to the UE, thereby enabling feedback of four different transmission hypotheses.

The Physical Downlink Control Channel (PDCCH) and/or Enhanced PDCCH (EPDCCH) may be used to carry downlink control information (DCI) such as scheduling decisions and power-control commands. More specifically, the DCI includes:
Downlink scheduling assignments, including PDSCH resource indication, transport format, hybrid-ARQ information, and control information related to spatial multiplexing (if applicable). A downlink scheduling assignment also includes a command for power control of the PUCCH used for transmission of hybnd-ARQ acknowledgements in response to downlink scheduling assignments.
Uplink scheduling grants, including PUSCH resource indication, transport format, and hybrid-ARQ-related information. An uplink scheduling grant also includes a command for power control of the PUSCH.
Power-control commands for a set of terminals as a complement to the commands included in the scheduling assignments/grants.

One PDCCH/EPDCCH carries one DCI message with one of the formats above. As multiple terminals can be scheduled simultaneously, on both downlink and uplink, it is suitable to transmit multiple scheduling messages within each subframe. Each scheduling message is transmitted on separate PDCCH/EPDCCH resources, and consequently there are typically multiple simultaneous PDCCH/EPDCCH transmissions within each cell. Furthermore, to support different radio-channel conditions, link adaptation can be used, where the code rate of the PDCCH/EPDCCH is selected by adapting the resource usage for the PDCCH/EPDCCH, to match the radio-channel conditions.

Messages transmitted over the radio link to users can be broadly classified as control messages or data messages. Control messages are used to facilitate the proper operation of the system as well as proper operation of each UE within the system. Control messages could include commands to control functions such as the transmitted power from a UE, signaling of Resource Blocks (RB) within which the data is to be received by the UE or transmitted from the UE.

In order to transmit the control messages across wireless channels reliably, forward error correction coding needs to be provided. Furthermore, the target and/or receiver (e.g. a UE or wireless device) of the control message transmission also needs to be incorporated.

The target may be incorporated by means different Radio Network Temporary Identifications (RNTIs). In LTE, a UE connected to the network is assigned a cell radio network temporary identification (C-RNTI). The CRNTI may be used to address the target of a control message transmission. Furthermore, there are control messages that need to be transmitted to more than one UE or to UE not yet assigned a C-RNTI. For these purposes, there are additional specifically defined RNTIs for use in an LTE network such as those listed in Table 1. The length of the RNTI in LTE is 16 bits.

TABLE 1
List of RNTI usages.

| | | Transport | Logical |
|---|---|---|---|
| RNTI | Usage | Channel | Channel |
| P-RNTI | Paging and System Information | PCH | PCCH |
| | change notification | | |
| SI-RNTI | Broadcast of System Information | DL-SCH | BCCH |
| M-RNTI | MCCH Information change | N/A | N/A |
| | notification | | |
| RA-RNTI | Random Access Response | DL-SCH | N/A |
| Temporary | Contention Resolution (when | DL-SCH | CCCH |
| C-RNTI | no valid C-RNTI is available) | | |
| Temporary | Msg3 transmission | UL-SCH | CCCH, |
| C-RNTI | | | DCCH, |
| | | | DTCH |
| C-RNTI | Dynamically scheduled unicast | UL-SCH | DCCH, |
| | transmission | | DTCH |
| C-RNTI | Dynamically scheduled unicast | DL-SCH | CCCH, |
| | transmission | | DCCH, |
| | | | DTCH |
| C-RNTI | Triggering of PDCCH ordered | N/A | N/A |
| | random access | | |
| Semi- | Semi-Persistently scheduled | DL-SCH, | DCCH, |
| Persistent | unicast transmission (activation, | UL-SCH | DTCH |
| Scheduling | reactivation and retransmission) | | |
| C-RNTI | | | |
| Semi- | Semi-Persistently scheduled | N/A | N/A |
| Persistent | unicast transmission (deactivation) | | |
| Scheduling | | | |
| C-RNTI | | | |
| TPC- | Physical layer Uplink power control | N/A | N/A |
| PUCCH- | | | |
| RNTI | | | |
| TPC- | Physical layer Uplink power control | N/A | N/A |
| PUSCH- | | | |
| RNTI | | | |

The control message carried by the EPDCCH is referred to as a downlink control information (DCI). Several different formats and corresponding lengths of DCI are defined in LTE: 0, 1, 1A, 1B, 1C, 1D, 2, 2A, 2B, 2C, 2D, 3, 3A and 4. For a given DCI format, the length may vary based on what system bandwidth is assumed.

The control message encoding process is schematically illustrated in FIG. 11. On the EPDCCH/PDCCH, a 16-bit cyclic-redundancy check (CRC) checksum is first computed from the bits of the control message. The CRC bits are scrambled by the RNTI for which the control message is addressed. The scrambling process is done by bit-wise XOR of the CRC bits and the RNTI bits. The scrambled CRC bits attached to the end of the control message bits. These bits are then encoded by a forward error correction code, which, in LTE, is based on a rate 1/3 tail-biting convolutional code. Since the EPDCCH has different sizes, a rate matching stage is employed to puncture or repeat the encoded bits to fit the available size of the EPDCCH. The rate matched coded bits are further scrambled by a UE-specific or cell-specific sequence to provide protection against inter-cell interference. The output bits are then mapped to QPSK symbols.

The LTE Rel-10 standard supports bandwidths larger than 20 MHz. One important requirement on LTE Rel-10 is to assure backward compatibility with LTE Rel-8. This should also include spectrum compatibility. That would imply that an LTE Rel-10 carrier, wider than 20 MHz, should appear as a number of LTE carriers to an LTE Rel-8 terminal. Each such carrier can be referred to as a Component Carrier (CC). In particular for early LTE Rel-10 deployments it can be expected that there will be a smaller number of LTE Rel-10-capable terminals compared to many LTE pre-Rel-10 terminals (in this disclosure LTE pre-Rel-10 terminals may interchangeably be called legacy terminals). Therefore, it is necessary to assure an efficient use of a wide carrier also for legacy terminals, i.e. that it is possible to implement carriers where legacy terminals can be scheduled in all parts of the wideband LTE Rel-10 carrier. The straightforward way to obtain this would be by means of Carrier Aggregation (CA). CA implies that an LTE Rel-10 terminal can receive multiple CC, where the CC have, or at least the possibility to have, the same structure as a Rel-8 carrier. CA is illustrated in FIG. 8.

The number of aggregated CC as well as the bandwidth of the individual CC may be different for uplink and downlink. A symmetric configuration refers to the case where the number of CCs in downlink and uplink is the same whereas an asymmetric configuration refers to the case that the number of CCs is different. It is important to note that the number of CCs configured in a cell may be different from the number of CCs seen by a terminal: A terminal may for example support more downlink CCs than uplink CCs, even though the cell is configured with the same number of uplink and downlink CCs.

Scheduling of a CC is done on the PDCCH and/or EPDCCH via downlink assignments. Control information on the PDCCH/EPDCCH is formatted as a Downlink Control Information (DCI) message. In Rel-8 a terminal only operates with one DL and one UL CC, the association between DL assignment, UL grants and the corresponding DL and UL CCs is therefore clear. In Rel-10 two modes of CA may be distinguished: The first case is very similar to the operation of multiple Rel-8 terminals, a DL assignment or UL grant contained in a DCI message transmitted on a CC is either valid for the DL CC itself or for associated (either via cell-specific or UE specific linking) UL CC. A second mode of operation augments a DCI message with the Carrier Indicator Field (CIF). A DCI containing a DL assignment with CIF is valid for that DL CC indicted with CIF and a DCI containing an UL grant with CIF is valid for the indicated UL CC. The DCI transmitted using EPDCCH which was introduced in Rel-11 can also carry CIF which means that cross carrier scheduling is supported also when using EPDCCH.

In typical deployments of Wireless Local Area Network (WLAN), carrier sense multiple access with collision avoidance (CSMA/CA) is used. CSMA/CA may be referred to as a Listen Before Talk (LBT) method and/or procedure. An example of an LBT method is illustrated in FIG. 4. In an LBT method a network node may not access/occupy a carrier and/or channel unless the channel is declared as Idle after “sensing”. The “sensing” may correspond to step 1 (the leftmost time period T1) in FIG. 4, where the transceiver performs a Clear Channel Assessment (CCA), which may comprise detecting an energy level on a certain carrier and/or channel and/or frequency. If the detected energy is above a certain level, the channel and/or carrier and/or frequency is considered be Busy and consequently not accessed/occupied by the network node. In other words this means that all transmissions related to one AP might be deferred in case a transmission on the same frequency to or from another AP, which is within range, can be detected. This is illustrated in step 3 in FIG. 4. On the other hand, if the energy level is below the certain level the channel and/or carrier is accessed/occupied by the network node. The latter is illustrated in step 2 (T2) in FIG. 4.

This means that the channel is sensed, and only if the channel is declared as Idle, a transmission is initiated. In case the channel is declared as Busy, the transmission is essentially deferred until the channel is found Idle. When the range of several APs using the same frequency overlap, this means that all transmissions related to one AP might be deferred in case a transmission on the same frequency to or from another AP which is within range can be detected. Effectively, this means that if several APs are within range, they will have to share the channel in time, and the throughput for the individual APs may be severely degraded. A general illustration of the listen before talk (LBT) mechanism is shown in FIG. 4. An LBT mechanism may be referred to as an LBT procedure and/or LBT method. If a network node uses an LBT procedure for transmission on radio resources, a carrier and/or channel can be said to be accessed by an LBT procedure.

Transmission and reception from a node, e.g. a terminal in a cellular system such as LTE, can be multiplexed in the frequency domain or in the time domain (or combinations thereof). Frequency Division Duplex (FDD) implies that downlink and uplink transmission take place in different, sufficiently separated, frequency bands. Time Division Duplex (TDD) implies that downlink and uplink transmission take place in different, non-overlapping time slots. Thus, TDD can operate in unpaired spectrum, whereas FDD requires paired spectrum.

Typically, the structure of the transmitted signal in a communication system is organized in the form of a frame structure. For example, LTE uses ten equally-sized subframes of length 1 ms per radio frame as illustrated in FIG. 2

In case of FDD operation (upper part of FIG. 12), there are two carrier frequencies, one for uplink transmission (fUL) and one for downlink transmission (fDL). At least with respect to the terminal in a cellular communication system, FDD can be either full duplex or half duplex. In the full duplex case, a terminal can transmit and receive simultaneously, while in half-duplex operation, the terminal cannot transmit and receive simultaneously (the base station is capable of simultaneous reception/transmission though, e.g. receiving from one terminal while simultaneously transmitting to another terminal). In LTE, a half-duplex terminal is monitoring/receiving in the downlink except when explicitly being instructed to transmit in a certain subframe.

In case of TDD operation (lower part of FIG. 12), there is only a single carrier frequency and uplink and downlink transmissions are always separated in time also on a cell basis. As the same carrier frequency is used for uplink and downlink transmission, both the base station and the mobile terminals need to switch from transmission to reception and vice versa. An essential aspect of any TDD system is to provide the possibility for a sufficiently large guard time where neither downlink nor uplink transmissions occur. This is required to avoid interference between uplink and downlink transmissions. For LTE, this guard time is provided by special subframes (subframe 1 and, in some cases, subframe 6), which are split into three parts: a downlink part (DwPTS), a guard period (GP), and an uplink part (UpPTS). The remaining subframes are either allocated to uplink or downlink transmission.

TDD allows for different asymmetries in terms of the amount of resources allocated for uplink and downlink transmission, respectively, by means of different downlink/uplink configurations. In LTE, there are seven different configurations as shown in FIG. 13. Note that in the description below, DL subframe can mean either DL or the special subframe.

To avoid severe interference between downlink and uplink transmissions between different cells, neighbor cells should have the same downlink/uplink configuration. If this is not done, uplink transmission in one cell may interfere with downlink transmission in the neighboring cell (and vice versa). Hence, the downlink/uplink asymmetry can typically not vary between cells, but is signaled as part of the system information and remains fixed for a long period of time.

### Licensed Assisted Access (LAA) to Unlicensed Spectrum Using LTE

Up to now, the spectrum used by LTE is dedicated to LTE. This has the advantage that LTE system may not have to care about the coexistence issue and the spectrum efficiency can be maximized. However, the spectrum allocated to LTE is limited which cannot meet the ever increasing demand for larger throughput from applications/services. Therefore, discussions are ongoing in 3GPP to initiate a new study item on extending LTE to exploit unlicensed spectrum in addition to licensed spectrum. Unlicensed spectrum can, by definition, be simultaneously used by multiple different technologies. Therefore, LTE may consider the coexistence issue with other system such as IEEE 802.11 (Wi-Fi). Operating LTE in the same manner in unlicensed spectrum as in licensed spectrum can seriously degrade the performance of Wi-Fi as Wi-Fi will not transmit once it detects the channel is occupied.

Furthermore, one way to utilize the unlicensed spectrum reliably is to defer essential control signals and channels on a licensed carrier. That is, as shown in FIG. 5, a UE is connected to a PCell in the licensed band and one or more SCells in the unlicensed band. In this disclosure a secondary cell in an unlicensed spectrum may interchangeably be denoted as license assisted access secondary cell (LAA SCell).

Periodic CSI measurements can be configured in LTE, where the UE is measuring the channel on CSI-RS in pre-defined subframes with a periodicity T={5, 10, 20, 40, 80} milliseconds.

If the eNB detects, by using LBT, that the LAA SCell channel is occupied at the configured subframe of a CSI-RS transmission, then the eNB may not be able to transmit the CSI-RS on that LAA SCelI.

In such subframe, the UE will not measure on a transmitted CSI-RS but on a signal transmitted by the equipment or node occupying the channel. This will lead to corrupt CSI estimates and lead to downlink throughput degradation, which is a problem.

Under rare occasions, the regulations allow the eNB to transmit CSI-RS even in an occupied subframe (less than 5% duty cycle); however this would lead to interference in the CSI estimation, which is a problem.

### SUMMARY

It is an object of embodiments described herein to address at least some of the problems and issues outlined above. It is possible to achieve this object and others by using methods and apparatuses as defined in the following embodiments.

According to a first aspect, a method for operating a wireless device in a wireless communication system, performed in a wireless device, the method comprises acquiring (S1) an indicator, wherein the indicator indicates presence of a reference signal and performing (S2) measurements on the reference signal based on whether the indicator was acquired. The indicator may be acquired by receiving a message. The message may be scrambled with a specific RNTI or the message may trigger a CSI report for one or several cells.

According to a second aspect, it is disclosed a wireless device, operating in a wireless communication system, the wireless device being adapted to acquire an indicator, wherein the indicator indicates presence of a reference signal and perform measurements on the reference signal based on whether the indicator was acquired. The wireless device mat be further adapted to acquire the indicator is by receiving a message. The message may be scrambled with specific RNTI or the message may trigger a CSI report for one or several cells.

In a third aspect, there is a method for operating a wireless device in a wireless communication system, performed in a network node, the method comprises providing (S11) an indicator to a wireless device, wherein the indicator indicates presence of a reference signal and providing (S12) the reference signal to enable the wireless device to perform measurements. The indicator is provided by sending a message. The message may either be scrambled with specific RNTI or trigger a CSI report for one or several cells.

In a fourth aspect, it is disclosed a network node operating in a wireless communication system, the network node being adapted to provide an indicator to a wireless device, wherein the indicator indicates presence of a reference signal and provide the reference signal to enable the wireless device to perform measurements. The network node may be adapted to provide the indicator by sending a message. The message may be scrambled with specific RNTI or the message may trigger a CSI report for one or several cells.

In a fifth aspect, there is a wireless device, operating in a wireless communication system, the wireless device comprises an acquiring module (95) adapted to acquire an indicator, wherein the indicator indicates presence of a reference signal and a measurement module (96) adapted to perform measurements on the reference signal based on whether the indicator was acquired.

In a sixth aspect, there is a network node for operating a wireless device in a wireless communication system, the network node comprises a first providing module adapted for providing (S11) an indicator to a wireless device, wherein the indicator indicates presence of a reference signal and a second providing module adapted for providing (S12) the reference signal to enable the wireless device to perform measurements.

The above network nodes, wireless devices and methods therein may be implemented and configured according to different optional embodiments to accomplish further features and benefits, to be described below.

One advantage is that CSI buffer corruption can be avoided. This may lead to improved quality of CSI estimates. This will in turn improve the DL throughput due to better link adaptation.

### BRIEF DESCRIPTION OF DRAWINGS

FIG. 1. The LTE downlink physical resource

FIG. 2 LTE time-domain structure

FIG. 3. Downlink subframe

FIG. 4. Illustration of listen before talk.

FIG. 5. License-assisted access (LAA) to unlicensed spectrum using LTE carrier aggregation.

FIG. 6. A wireless device

FIG. 7. A network node

FIG. 8. Carrier Aggregation.

FIG. 9. A method in a wireless device

FIG. 10. A method in a network node

FIG. 11. Control message encoding process

FIG. 12. Uplink/downlink time/frequency structure for LTE in case of FDD and TDD.

FIG. 13. Different downlink/uplink configurations in case of TDD.

FIG. 14. A schematic diagram illustrating an example of a wireless device.

FIG. 15. A schematic diagram illustrating an example of a network node.

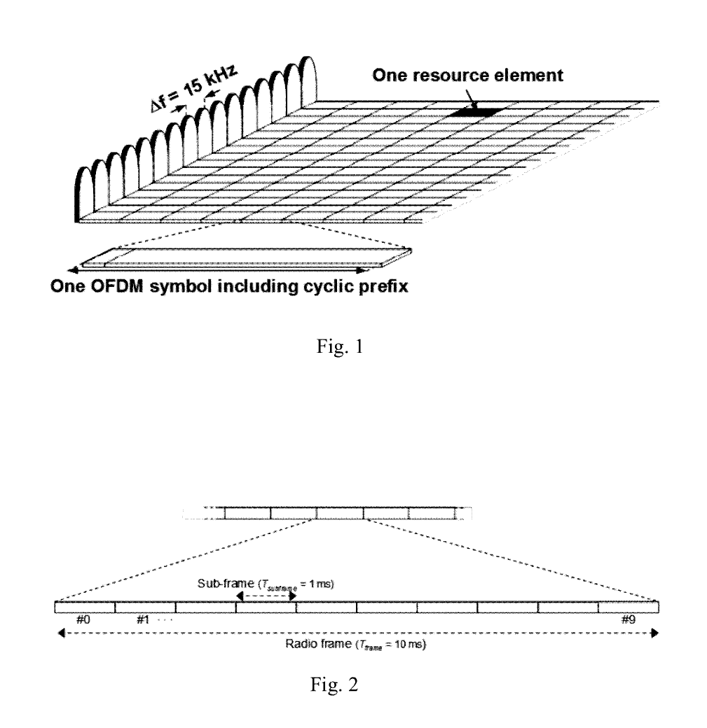

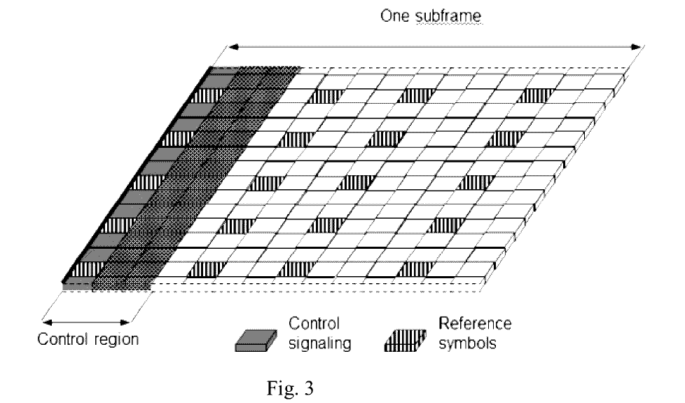

### DETAILED DESCRIPTION

The present invention aims at solving the problems described above by methods and apparatuses described herein.

E.g. in one aspect, a UE first detects whether the CSI-RS is present in a subframe before taking the CSI-RS measurement into account in the CSI processing and reporting. The detection if CSI-RS is present could either be blind by the UE, or guided by explicit signaling from an eNB

The presence of CSI-RS in e.g. an LAA Scell, may have to be determined on a quick time basis as the eNB will decide on very short time frame whether or not to transmit a specific subframe when operating in an unlicensed radio spectrum.

There are disclosed two approaches for how to indicate the presence of a CSI-RS in e.g. an LAA SCell.

Approach One:

It is possible to introduce a specific indicator that indicates the presence of the CSI-RS like for example a specific DCI message that is scrambled with specific RNTI and indicates the presence of CSI-RS on a specific carrier or group of carriers. This would require that the message is sent on a search space that is common for many UEs, i.e. on e.g. Pcell together with that the DCI message indicates to which SCell (e.g. LAA SCell) and when in time (e.g. for which subframes) the message applies. This would allow both periodic and aperiodic CSI reporting. The specific RNTI can for example be named CSI-RNTI. The DCI message that is used to send the CSI-RNTI can be DCI format 0/1A (currently have the same size). The bits that are available in the DCI message would indicate which carriers and potentially when in the time the CSI-RS occurs.

Approach Two:

A different approach is instead that the presence of the CSI-RS is indicated by the UE receiving an UL Grant which indicates that an aperiodic CSI message should be sent for the specific cell. This would allow aperiodic CSI reporting. In case the UL Grant is sent on the same SCell as the aperiodic CSI report is triggered for, it is easy for the eNB to ensure that CSI-RS is transmitted together with the UL grant. If however the UL grant indicates an aperiodic CSI-RS report for a different cell than in which the UL grant is sent, it would not be possible to transmit CSI-RS in the first subframe after the eNB has occupied the channel since the eNB cannot ensure that the channel is occupied and/or available on the carrier for which the aperiodic CSI is indicated to be reported for. If however the subframe is a later subframe within the eNBs TXOP the eNB can be aware of that it has occupied the channel and indicated the presence of the CSI-RS on one or more than one SCell(s) in which the UL Grant is sent.

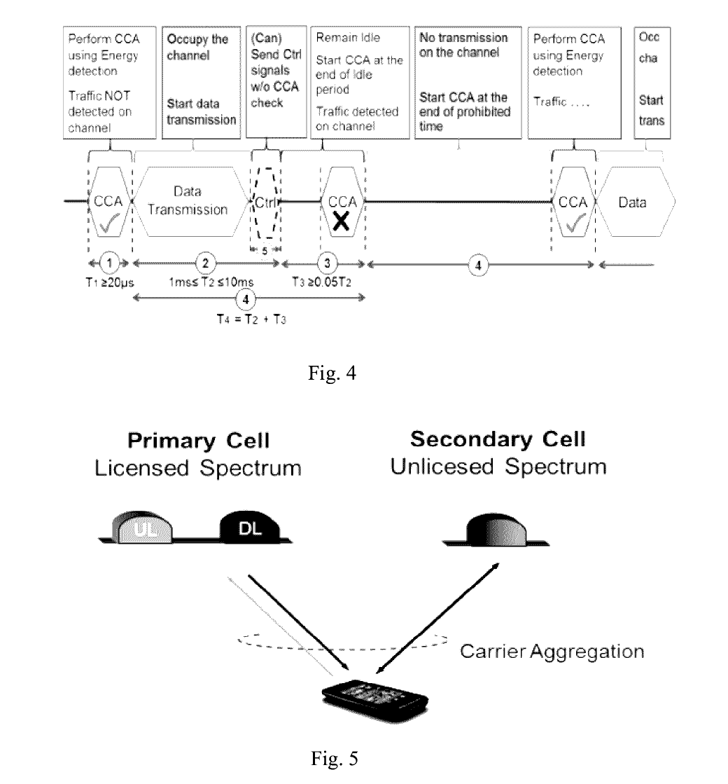

TXOP may be defined as a bounded time interval during which a station or eNB or UE can send as many frames or subframes as possible (as long as the duration of the transmissions does not extend beyond the maximum duration of the TXOP). Referring again to FIG. 4, time interval 2 (T2) can be considered to correspond to TXOP. The CSI-RS framework is a UE specific framework, i.e. a specific UE is not aware of other UEs CSI-RS. Further the CSI-RS are configured currently by a specific periodicity and offset. The cells for which an aperiodic CSI report is triggered are given by a bit field in the UL grant. Which cells are associated with which bit value may be or is, either predetermined or configured by RRC. Multiple cells can be configured for the same bit value.

Per CSI process, the UE may be configured with a rather short periodicity of CSI-RS as the eNB cannot guarantee to succeed with LBT for lower periodicity based CSI-RS configuration. More specifically there is or may be a relationship between the TXOP used by the eNB and CSI-RS configuration. If periodicity of the CSI-RS is such that a single CSI-RS occasion is ensured within a TXOP in which the eNB operates, the CSI-RS can occur at any time occasion within the TXOP. If the CSI-RS would occur in the first subframe and potentially in the second subframe within the TXOP, it could be difficult for the eNB to indicate accurately that the CSI-RS is present on any other carrier than the carrier on which the UL Grant is sent. In that sense it would be easy to operate CSI-RS configurations if at least two CSI-RS occasions occur within a single TXOP occasion with maximum difference in time between them. This ensures that the there is always a CSI-RS resource occasion for which it is possible for the eNB to indicate presence to the UE to measure on, even for a cell different on which the UL Grant is sent. The current defined CSI-RS periodicities are 5, 10, 20, 40 and 80 ms. The mainly considered TXOP to design LAA for, are 4 and 10 ms. A TXOP of 10 ms can be supported by configuring the CSI-RS with a periodicity of 5 ms. This is based on the assumption that the CSI-RS can occur in any subframe within the TXOP. It is worth noting that DwPTS does not support CSI-RS configurations. Therefore, if the last DL subframe is corresponding to DwPTS subframe, a CSI-RS configuration for such subframe may be defined. For a TXOP of 4 ms a new tighter periodicity of CSI-RS may be introduced. This may ensure both a single or double CSI-RS occasion. For the single case 4 ms periodicity is sufficient and for double CSI-RS occasion 2 ms periodicity may be required. To simplify the eNB processing it is proposed to allow that there are at least two CSI-RS occasions within the applicable TXOP for LAA. This can be seen as an eNB implementation aspect purely. Although it relies on the standard it is not standard specific how the eNB configures the CSI-RS resources for the UE.

Given that there is multiple CSI-RS occasions within the TXOP either of the above two mentioned UE and eNB solutions to determine the CSI-RS resources are applicable.

The other component of the CSI measurement is the interference measurement. The CSI-IM resource can be configured in the same way on an LAA SCell as on a licensed SCell. The assumption for the CSI-IM resource, that the serving eNB does not transmit anything on these resources, may advantageously be kept. This may also include any potential reservation signal that is under discussion.

In yet another eNB specification implementation aspect, the eNB configures Zero power CSI-RS in all subframes wherein it has configured CSI-RSs for a UE. The Zero power CSI-RS is assumed when performing rate matching for EPDCCH/PDCCH. The indicator (approach one or approach two) indicates to the UE whether or not the CSI-RS is available in the configured CSI-RS resources (for a specific UE there does not need to be a CSI-RS configuration for a Zero power CSI-RS configuration).

The other component of the CSI measurement is the interference measurement. The CSI-IM resource can be configured in the same way on an LAA SCell as on a licensed SCell. The assumption for the CSI-IM that the serving eNB does not transmit anything on these resources may preferably be kept. This may also include any potential reservation signal that is under discussion.

Since the presence of CSI-RS is not guaranteed on a LAA SCell, the UE detects an indicator that informs the UE whether the CSI-RS is present or not. After this indicator is received, the UE performs the applicable measurements and reports the CSI measurement if requested to do so.

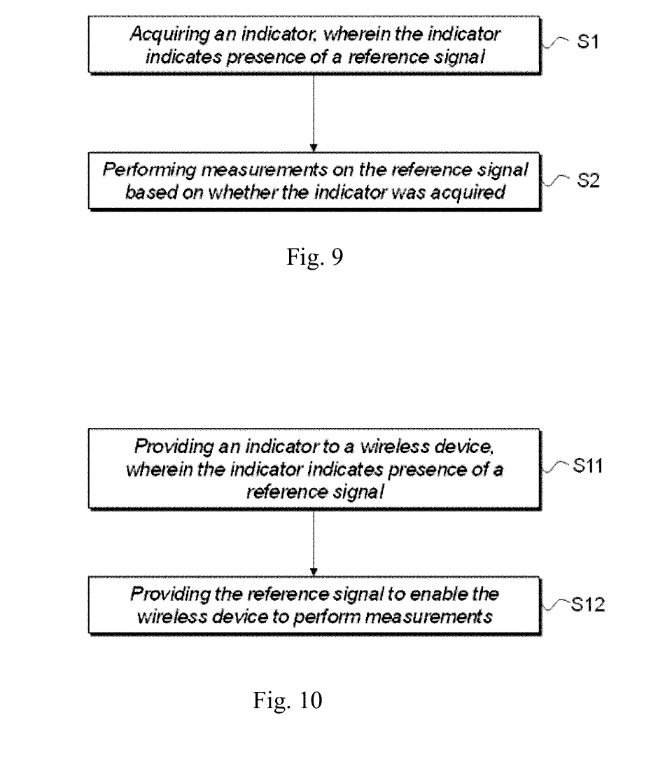

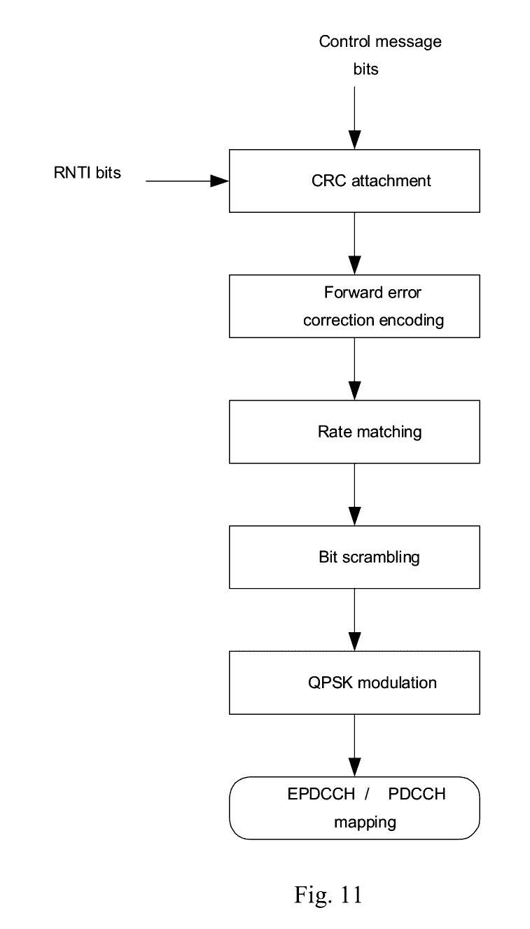

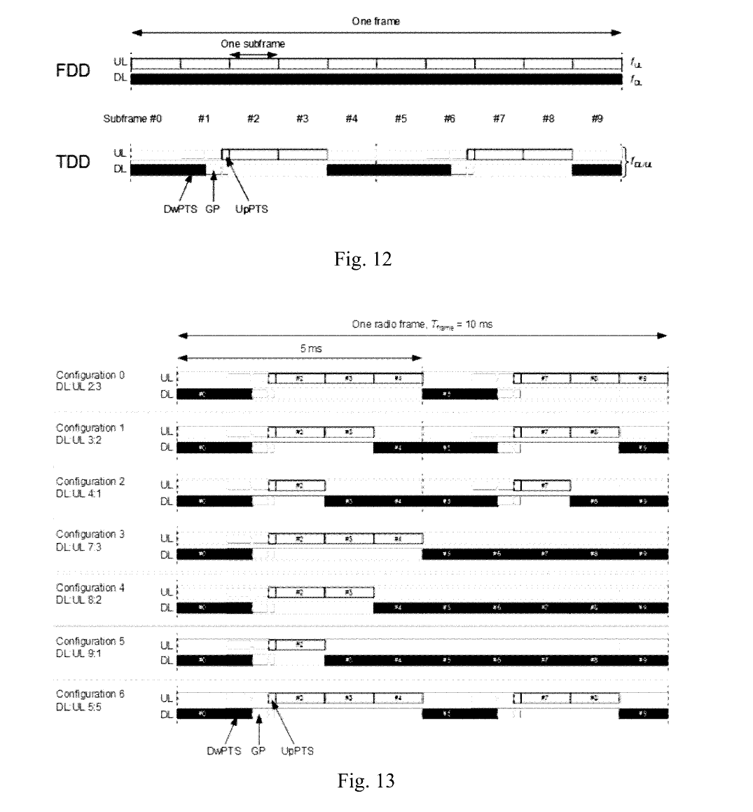

A schematic view of an embodiment of a method for operating a wireless device 90, is depicted in FIG. 9. The method comprises acquiring, S1, an indicator, wherein the indicator indicates presence of a reference signal and performing, S2, measurements on the reference signal based on whether the indicator was acquired. The indicator may optionally indicate presence of a reference signal in a cell and/or carrier accessed by LBT as e.g. an LAA SCell on a carrier which may be different from a PCell which is serving the wireless device. Acquiring an indicator wherein the indicator indicates presence of a reference signal may, according to embodiments herein, comprise e.g. detecting the presence of another reference signal, such as e.g. DRS and/or CRS. Since detecting e.g. CRS, is more reliable than detecting CSI-RS by itself, this may be considered one option on how to determine whether the CSI-RS is present is available on the carrier for which the CSI is to be reported for. If the indicator is acquired, by e.g. detecting presence of CRS, and the CSI-RS has been configured to occur in that subframe, then the wireless device 90 can use the CSI-RS in that subframe for reporting CSI.

A schematic view of a wireless device, 90, is depicted in FIG. 7. A wireless device, 90, may comprise a transmitter unit, 93, a receiver unit, 92, a memory unit, 91, an acquiring module, 95, and a measurement module, 96.

A wireless device may generally be a device configured for wireless device-to-device communication (it may be a D2D device) and/or a terminal for a wireless and/or cellular network, in particular a mobile terminal, for example a mobile phone, smart phone, tablet, PDA, etc. The term “wireless device” is used interchangeably with the term “UE” or “user equipment” throughout this disclosure. A wireless device may be a node of or for a wireless communication network as described herein. It may be envisioned that a user equipment is adapted for one or more RATs, in particular UTRAN or WCDMA UTRA. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory and/or a memory unit, which may be adapted to be accessible for reading and/or writing by the controller and/or control circuitry. A node or device of or for a wireless communication network, in particular a node or device for device-to-device communication, may generally be a user equipment or D2D device. It may be considered that a user equipment is configured to be a user equipment adapted for WCDMA UTRAN and/or LTE eUTRAN and/or WiFi.

A storage medium may be adapted to store data and/or store instructions executable by control circuitry and/or a computing device, the instruction causing the control circuitry and/or computing device to carry out and/or control any one of the methods described herein when executed by the control circuitry and/or computing device. A storage medium may generally be computer-readable, e.g. an optical disc and/or magnetic memory and/or a volatile or non-volatile memory and/or flash memory and/or RAM and/or ROM and/or EPROM and/or EEPROM and/or buffer memory and/or cache memory and/or a database.

A schematic view of an embodiment of a method for operating a network node 90 is depicted in FIG. 10. The method comprises providing, S11, an indicator to a wireless device, wherein the indicator indicates presence of a reference signal; and providing, S12, the reference signal to enable the wireless device to perform measurements. The indicator may optionally indicate presence of a reference signal in a cell and/or carrier accessed by LBT as e.g. an LAA SCell on a carrier which may be different from a PCell which is serving the wireless device.

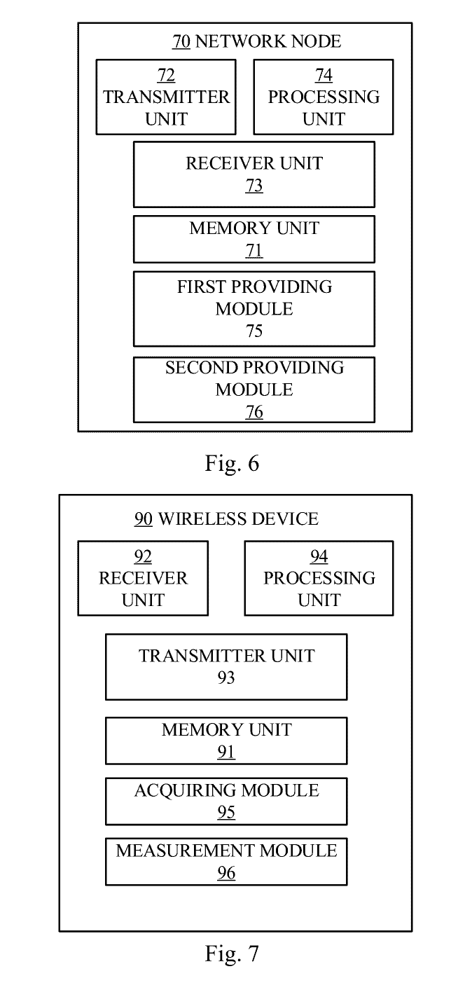

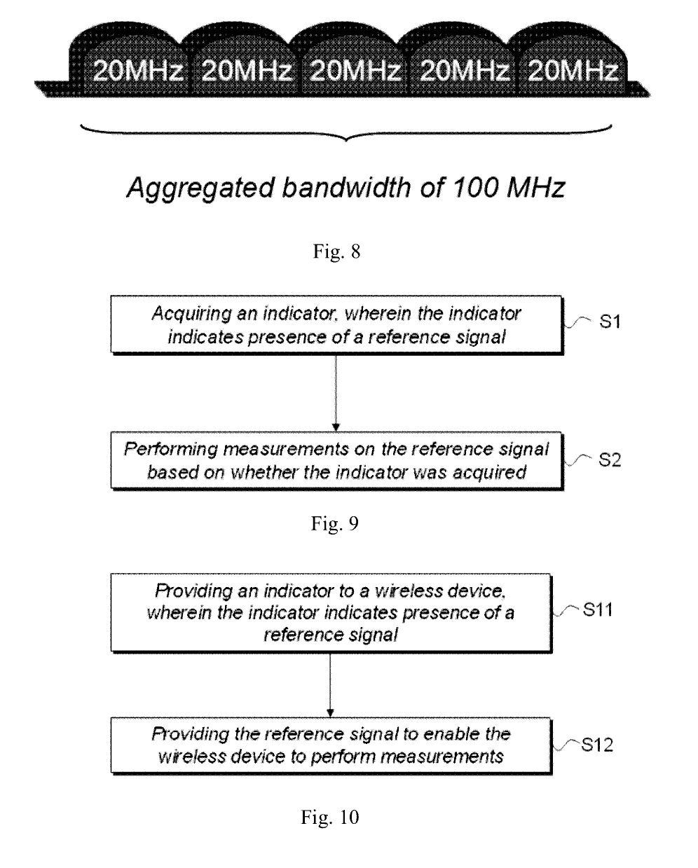

A network node, 70, is depicted in FIG. 6, and a network node may comprise a transmitter unit, 72, a receiver unit, 73, a memory unit, 71, a first providing module, 75 and a second providing module, 76.

A wireless device in this disclosure may be a UE adapted to work in a wireless communication network.

A network node may be e.g. a base station and/or an Access Point and/or an eNB in eUTRAN or a NodeB in UTRAN.

A wireless communication network may be a WLAN according to IEEE and/or eUTRAN and/or UTRAN network according to 3GPP.

TXOP may be defined as a bounded time interval during which a station can send as many frames as possible (as long as the duration of the transmissions does not extend beyond the maximum duration of the TXOP) or TXOP may be defined as a bounded time interval during which a eNB/UE can send as many subframes as possible (as long as the duration of the transmissions does not extend beyond the maximum duration of the TXOP). T4 in FIG. 4 may be considered an example of TXOP in case of a LBT access of an LTE carrier and/or channel.

Acquiring an indicator may be receiving a message and/or based on the received message deduce whether the indicator is present or not. Deduce whether the indicator is present or not may mean determining if the message was intended for the wireless device or not by e.g. descrambling the message with a specific RNTI as explained above. E.g. if the wireless device receives a message and/or can decode the CRC attachments successfully it can deduce that the indicator is present.

Deducing that an indicator is present may additionally and/or alternatively mean that based on the content in the message, deduce that the indicator is present.

E.g. when a wireless device receives “CSI Request field for PDCCH/EPDCCH with uplink DCI format in UE specific search” message and/or a UL Grant message, the wireless device may deduce that an indicator is present if an aperiodic CSI report is triggered for one or several cells.

Receiving a message may include receiving a message from a network node and/or via a cell associated with the wireless device.

A cell associated with a wireless device may mean that the cell may be mandated by the network node to report CSI for said cell and examples of such cells may be e.g. PCell, SCell, or LAA SCell.

CSI may comprise Channel Quality Indicator (CQI), and/or Precoding Matrix Indicator (PMI) and/or Ranking Indicator (RI) and/or Interference Measurement (IM).

A CSI report may contain feedback to the network node from the wireless device. The feedback may relate to the downlink channel state for a cell associated with the wireless device.

A reference signal may be a CSI-RS as defined in 3GPP.

Performing measurements on the reference signal may comprise measuring and/or estimating signal strength and/or signal-to-noise ratio, pathloss. Performing measurements may also comprise determining and/or estimating measurements for e.g. signal strength and/or signal-to-noise ratio, pathloss based on received data in previously received Resource Blocks wherein the previously received data is stored in a memory in the wireless device.

Providing an indicator to a wireless device may comprise sending a message to the wireless device via a cell associated with the wireless device and/or via a second network node.

Providing an indicator may also comprise sending a message which may be scrambled with a specific RNTI wherein the specific RNTI may address and/or target only wireless devices that are associated with cells associated with the indicator. Consequently, the wireless device may decode the CRC attachments successfully if it is addressed by the network node and the wireless device can deduce that the indicator is present.

Providing the reference signal may comprise transmitting a CSI-RS in a cell associated with the wireless device to enable the wireless device to perform measurements. The transmission of the CSI-RS may be carried out via a second network node.

There is also disclosed a first computer program, 225, 235, comprising instructions, which when executed on a processing circuitry, (210, cause the processing circuitry, 210, to carry out and/or control the methods in the wireless device 90, as described herein.

A second computer program is also disclosed. The second computer program comprises instructions, which when executed on a processing circuitry, 110 cause the processing circuitry, 110, to carry out and/or control the methods in the network node, 70, as described herein.

There is also disclosed a first carrier, 230, containing the first computer program wherein the carrier is one of an electronic signal, optical signal, radio signal, computer or processing circuitry readable storage medium.

There is also disclosed a second carrier containing the second computer program wherein the carrier is one of an electronic signal, optical signal, radio signal, computer or processing circuitry readable storage medium.

A wireless device 90, is disclosed wherein the wireless device 90, is adapted to being configured with an acquiring module, 95, adapted to acquire an indicator, wherein the indicator indicates presence of a reference signal. The wireless device 90, further comprises a measurement module, 96, adapted to perform measurements on the reference signal based on whether the indicator was acquired.

A network node, 70, is disclosed. The network node comprises a first providing module, 75, adapted for providing, S11, an indicator to a wireless device, wherein the indicator indicates presence of a reference signal. The network node additionally comprises a second providing module, 76, adapted for providing, S12, the reference signal to enable the wireless device to perform measurements.

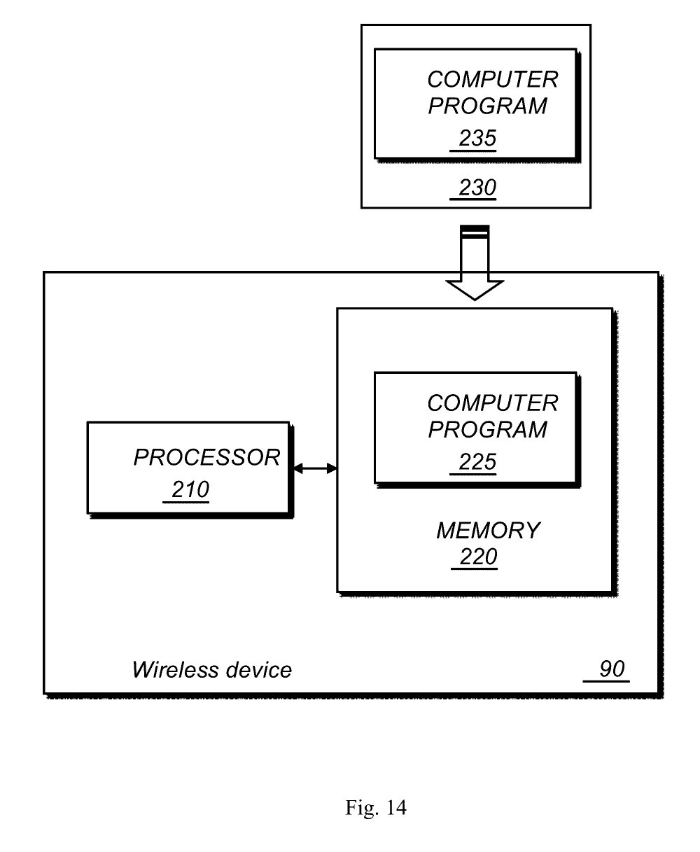

FIG. 14 is a schematic diagram illustrating an example of a wireless device.

In this particular example, at least some of the steps, functions, procedures, modules and/or blocks described herein are implemented in a computer program 225; 235, which is loaded into the memory 220 for execution by processing circuitry including one or more processors 210. The processor(s) 210 and memory 220 are interconnected to each other to enable normal software execution. An optional input/output device may also be interconnected to the processor(s) and/or the memory to enable input and/or output of relevant data such as input parameter(s) and/or resulting output parameter(s).

The term ‘processor’ should be interpreted in a general sense as any system or device capable of executing program code or computer program instructions to perform a particular processing, determining or computing task.

The processing circuitry including one or more processors is thus configured to perform, when executing the computer program, well-defined processing tasks such as those described herein.

The processing circuitry does not have to be dedicated to only execute the above-described steps, functions, procedure and/or blocks, but may also execute other tasks.

According to another example, there is provided a computer program 225; 235 comprising instructions, which when executed by at least one processor 210, cause the at least one processor 210 to:
acquire an indicator, wherein the indicator indicates presence of a reference signal
perform measurements on the reference signal based on whether the indicator was acquired

In yet another example, the proposed technology also provides a carrier 220; 230 comprising the computer program 225; 235, wherein the carrier is one of an electronic signal, an optical signal, an electromagnetic signal, a magnetic signal, an electric signal, a radio signal, a microwave signal, or a computer-readable storage medium.

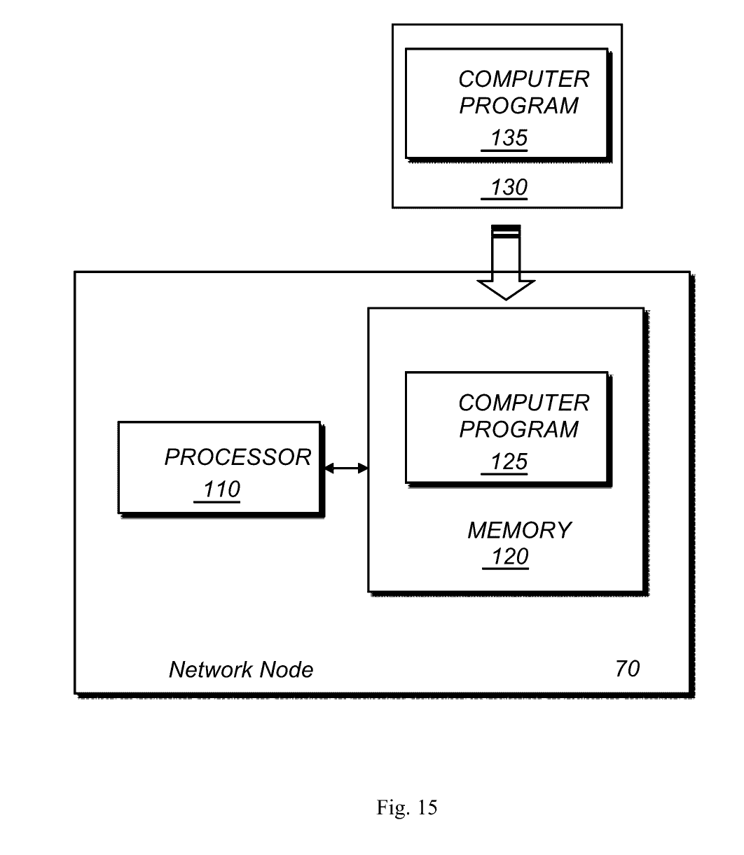

FIG. 15 is a schematic diagram illustrating an example of a network node.

In this particular example, at least some of the steps, functions, procedures, modules and/or blocks described herein are implemented in a computer program 125; 135, which is loaded into the memory 120 for execution by processing circuitry including one or more processors 110. The processor(s) 110 and memory 120 are interconnected to each other to enable normal software execution. An optional input/output device may also be interconnected to the processor(s) and/or the memory to enable input and/or output of relevant data such as input parameter(s) and/or resulting output parameter(s).

The term ‘processor’ should be interpreted in a general sense as any system or device capable of executing program code or computer program instructions to perform a particular processing, determining or computing task.

The processing circuitry including one or more processors is thus configured to perform, when executing the computer program, well-defined processing tasks such as those described herein.

The processing circuitry does not have to be dedicated to only execute the above-described steps, functions, procedure and/or blocks, but may also execute other tasks.

According to another example, there is provided a computer program 125; 135 comprising instructions, which when executed by at least one processor 110, cause the at least one processor 110 to:
provide an indicator to a wireless device, wherein the indicator indicates presence of a reference signal
provide the reference signal to enable the wireless device to perform measurements

In yet another example, the proposed technology also provides a carrier 120; 130 comprising the computer program 125; 135, wherein the carrier is one of an electronic signal, an optical signal, an electromagnetic signal, a magnetic signal, an electric signal, a radio signal, a microwave signal, or a computer-readable storage medium.

By way of example, the software or computer program 125; 135; 225; 235 may be realized as a computer program product, which is normally carried or stored on a computer-readable medium 120; 130; 220; 230, in particular a non-volatile medium. The computer-readable medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program may thus be loaded into the operating memory of a computer or equivalent processing device for execution by the processing circuitry thereof.

There is disclosed a wireless device, operating in a wireless communication system, the wireless device comprises:
an acquiring module (95) adapted to acquire an indicator, wherein the indicator indicates presence of a reference signal
a measurement module (96) adapted to perform measurements on the reference signal based on whether the indicator was acquired

There is also disclosed A network node for operating a wireless device in a wireless communication system, the network node comprises:
a first providing module (75) adapted for providing (S11) an indicator to a wireless device, wherein the indicator indicates presence of a reference signal
a second providing module (76) adapted for providing (S12) the reference signal to enable the wireless device to perform measurements

Handling CSI measurements on LAA SCells may have to be handled with some care. The CSI measurements may comprise two different measurement resources, i.e. CSI-RS and CSI-IM. The reason is that CSI measurement opportunity (e.g. subframe) at the UE will be much more difficult when operating an LAA SCell because the eNB may perform LBT before transmitting CSI-RS in a subframe. One possibility is to extend the CSI-RS design so that the UE is configured to expect CSI-RS in a subframe or a set of subframes with a configured periodicity and offset. The eNB then performs LBT on CSI-RS and the UE would blindly detect the presence of the CSI-RS. It is however notable that it is very difficult to get a good blind deletion of a single CSI-RS resource. The risk is large for falsely detecting the presence of CSI-RS, i.e. the UE believes that the eNB has transmitted the CSI-RS but it has not. It can be observed that in previous contributions that the detection of a single CSI-RS is not sufficient. Therefore it may be concluded that a beneficial approach would be to let the presence of a specific CSI-RS to be indicated to the UE Before discussing more on the different approaches on CSI-RS transmissions, we first discuss the value of periodic and aperiodic CSI reports for LAA SCells. It is assumed that the interference conditions may be very varying on an LAA SCells over time. At the same time the scenario that is considered is a very low mobility scenario. The underlying spatial properties and channel quality (if the interference conditions are excluded) is hence rather static over time. At the same time it is assumed that the LAA SCell will mainly be used to expand the data rate, i.e. if the eNB has large amount of DL data to schedule to UE the eNB will utilize the LAA SCells. Correspondingly the LAA SCell will be used for significant time before the eNB has emptied its transmission buffer. Due to this, it is unlikely that the eNB will activate LAA SCells without scheduling data on them for a long period of time. Periodic CSI reports are mainly used to get a good starting point for the link adaptation and scheduling and when data is being continuously scheduled the resolution of the periodic CSI report is not good enough. Due to all the above reasons the most practical approach would be to rely only on aperiodic CSI reports for LAA SCell.

Therefore it can be proposed that LAA SCells do not support periodic CSI reports, but do support aperiodic CSI reports Going back to the discussion on how the UE measures on the CSI-RS resource. In general it can be assumed that the CSI-RS presence is indicated to the UE. This may be done on a quick time basis as the eNB will decide on very short time frame whether or not to transmit a specific set of subframe(s).

It can be considered to introduce a specific indicator that indicates the presence of the CSI-RS in an LAA SCell (e.g. an SCell which is accessed by LBT), as for example a specific DCI message that is scrambled with specific RNTI and indicates the presence of CSI-RS on a specific carrier or group of carriers. This would require that the message is sent on a search space that is common for many UEs, e.g. on Pcell. This together with that the DCI message indicates which SCell the message applies to and potentially when in time.

A different approach is that the presence of the CSI-RS is indicated to the UE receiving the UL Grant which indicates that an aperiodic CSI message should be sent for the specific cell. In case the UL Grant is sent on the same SCell as the aperiodic CSI report is triggered for, it is easy for the eNB to ensure that CSI-RS is transmitted together with the UL grant. If however the UL grant indicates an aperiodic CSI-RS report for a different cell than what the UL grant is sent on, it would not be possible to transmit CSI-RS in the first subframe after the eNB has occupied and/or accessed the channel as the eNB cannot ensure that the channel is occupied on the carrier for which the aperiodic CSI is indicated to be reported for. If however the subframe is later subframe within the eNBs TXOP the eNB can be aware of that it has occupied the channel and indicate the presence of the CSI-RS on the SCell that the UL Grant is sent on.

The CSI-RS framework is a UE specific framework, i.e. a specific UE is not aware of other UEs CSI-RS. Further the CSI-RS are configured currently by a specific periodicity and offset. In addition there are three CSI processes defined.

Per CSI process the UE may be configured with a rather short periodicity of CSI-RS as the eNB cannot guarantee to succeed with LBT for a longer periodicity based CSI-RS configuration. More specifically there is a relationship between the TXOP used by the eNB and CSI-RS configuration. If periodicity of the CSI-RS can ensure that a single CSI-RS occasion is within a TXOP that the eNB operates, the CSI-RS can occur at any time occasion within the TXOP. If the CSI-RS would occur in the first subframe and potentially second subframe of the TXOP it could be difficult for the eNB to be able to indicate accurately that the CSI-RS is present on any other carrier than on the same carrier as the UL Grant is sent on, due to processing delay. In that sense that it would be easier to operate CSI-RS configurations if at least two CSI-RS occasion occur within a single TXOP occasion with maximum difference in time between them. This ensures that the there is always a CSI-RS resource occasion that is possible for the eNB to indicate to the UE to measure on. The current defined CSI-RS periodicities are 5, 10, 20, and 80 ms. The mainly considered TXOP to the LAA design is currently 4 and ms. A TXOP of 10 ms can be supported by configuring the CSI-RS with a periodicity of 5 ms. This assuming that the CSI-RS can occur in any subframe within the TXOP. It is worth noting here that DwPTS does not support CSI-RS configurations so if the last DL subframe is corresponding to DwPTS subframe, a CSI-RS configuration for such subframe could be defined. For a TXOP of 4 ms a new tighter periodicity of CSI-RS may be introduced. This to ensure a single or double CSI-RS occasion. For the case of only having single CSI-RS occasion within a 4 ms TXOP, a 4 ms periodicity is sufficient and for double CSI-RS occasion 2 ms periodicity is proposed. To simplify the eNB processing it is proposed to allow that there are at least two CSI-RS occasions within the applicable TXOP for LAA.

Therefore one may consider to introduce a CSI-RS periodicity of 2 ms on carriers which are accessed by LBT

Given that there are multiple CSI-RS occasions within the TXOP either of the above two discussed solutions are possible. It is however noted that first approach is based on specific RNTI that is broadcast and the second approach is based on that the eNB transmits an UL Grant per UE. The first solution would use of common search to indicate the message, which is a limited resource. The second approach however assumes that the number of scheduled UEs is rather low. The last assumption seems to be motivated by that the LAA SCell will be seen as a small cell and hence cannot contain the same amount of UEs within its coverage area as a macro cell.

Therefore, it mat be considered that the presence of CSI-RS is indicated by an UL grant triggering an aperiodic CSI report for the indicated SCell (e.g. an SCell accessed by LBT)

The other component of the CSI measurement is the interference measurement. The CSI-IM resource can be configured in the same way on an LAA SCell as on an licensed SCell. The assumption for the CSI-IM is that the serving eNB does not transmit anything on the configured resources. This may also include any potential reservation signal that is under discussion.

Consequently, it may be anticipated that there is no need to change the CSI-IM resource handling for an LAA SCell

There is a risk that two different transmitting entities either eNB, UEs, ST or APs collide over the air and both grab the channel. If the UE would in such an occasion measure on a CSI-RS the measurement would be very noise and doesn't represent the general conditions of the channel. Within the current LTE design it is allowed for the UE to average CSI-RS measurement across different CSI-RS occasions. If this occurs in the above situation the measurement error will propagate in time and would not correspond to the actually CSI. It is therefore preferred if the CSI-RS measurements is limited to a single CSI-RS occasion and averaging over time is not allowed. Therefore it may be considered beneficial if CSI-RS measurements are only done per CSI-RS occasion

In order to provide preconditions for efficient design, the following characteristics are considered:
LAA SCell do not support periodic CSI reports, but do support aperiodic CSI reports
Introduce a CSI-RS periodicity of 2 ms
The presence of CSI-RS is indicated by a UL grant triggering an aperiodic CSI report for the indicated SCell
No need to change the CSI-IM resource handling
CSI-RS measurements are only done per CSI-RS occasion

### ABBREVIATIONS

Abbreviation Explanation
CQI Channel-Quality Indicator
CSI Channel-State Information
CSI-IM Channel-State Information—Interference Measurement
CSI-RS Channel-State Information—Reference Signal
DL Downlink
DMRS Demodulation Reference Signals
eNB evolved NodeB, base station
PMI Precoding Matrix Indicator
RI Rank Indicator
TTI Transmission-Time Interval
UE User Equipment
UL Uplink
LA License Assisted
LAA License Assisted Access
DRS Discovery Reference Signal

1-20. (canceled)

21. A method for operating a wireless device in a wireless communication system, the method comprising the wireless device:
acquiring an indicator, wherein the indicator indicates presence of a reference signal; and
performing measurements on the reference signal based on whether the indicator was acquired.

22. The method of claim 21, wherein the acquiring the indicator comprises receiving a message.

23. The method of claim 22, wherein the message is scrambled with a specific Radio Network Temporary Identification (RNTI).

24. The method of claim 22, wherein the message triggers a Channel-State Information (CSI) report for one or several cells.

25. The method of claim 21, wherein the indicator indicates presence of a reference signal on a License Assisted Access (LAA) Secondary Cell (SCell).

26. A wireless device, operating in a wireless communication system, the wireless device comprising:
processing circuitry;
memory containing instructions executable by the processing circuitry whereby the wireless device is configured to:
acquire an indicator, wherein the indicator indicates presence of a reference signal;
perform measurements on the reference signal based on whether the indicator was acquired.

27. The wireless device of claim 26, wherein the wireless device is configured to acquire the indicator by receiving a message.

28. The wireless device of claim 27, wherein the message is scrambled with specific Radio Network Temporary Identification (RNTI).

29. The wireless device of claim 27, wherein the message is triggering a Channel-State Information (CSI) report for one or several cells.

30. The wireless device of claim 26, wherein the indicator indicates presence of a reference signal on an License Assisted Access (LAA) Secondary Cell (SCell).

31. A method for operating a network node in a wireless communication system, the method comprising the network node:
providing an indicator to a wireless device, wherein the indicator indicates presence of a reference signal; and
providing the reference signal to enable the wireless device to perform measurements.

32. The method of claim 31, wherein the providing the indicator comprising providing the indicatory by sending a message.

33. The method of claim 32, wherein the message is scrambled with specific Radio Network Temporary Identification (RNTI).

34. The method of claim 32, wherein the message triggers a Channel-State Information (CSI) report for one or several cells.

35. The method of claim 31, wherein the indicator indicates presence of a reference signal on an License Assisted Access (LAA) Secondary Cell (SCell).

36. A network node operating in a wireless communication system, the network node comprising:
processing circuitry;
memory containing instructions executable by the processing circuitry whereby the network node is configured to:
provide an indicator to a wireless device, wherein the indicator indicates presence of a reference signal;
provide the reference signal to enable the wireless device to perform measurements.

37. The network node of claim 36, wherein the network node is configured to provide the indicator by sending a message.

38. The network node of claim 37, wherein the message is scrambled with specific Radio Network Temporary Identification (RNTI).

39. The network node of claim 37, wherein the message triggers a Channel-State Information (CSI) report for one or several cells.

40. The network node of claim 36, wherein the indicator indicates presence of a reference signal on an License Assisted Access (LAA) Secondary Cell (SCell).
